(19) United States
(12) Patent Application Publication
(10) Pub. No.: US 2022/0295835 A1
(43) Pub. Date: Sep. 22, 2022

(54) COLORED HYDROGEL MATERIALS AND METHOD MAKING SAME

(71) Applicant: V. Mane Fils, Bar Sur Loup (FR)

(72) Inventors: Jason C. Cole, Georgetown, OH (US); Kevin Arthur Heitfeld, Cincinnati, OH (US); Robert B. Wieland, Cleves, OH (US)

(73) Assignee: V. Mane Fils, Bar Sur Loup (FR)

(21) Appl. No.: 17/619,298

(22) PCT Filed: Jun. 17, 2020
(86) PCT No.: PCT/EP2020/066708

§ 371 Date: Dec. 15, 2021

Related U.S. Application Data
(60) Provisional application No. 62/864,863, filed on Jun. 21, 2019.

(51) Int. Cl. A23L 5/42; A23L 29/281

(52) U.S. Cl. CPC A23L 5/42; A23L 29/284; A23V 2002/00

(57) ABSTRACT

Described herein is a method for making colored hydrogel-based materials, and products relating thereto. The method includes applying an aqueous colorant composition comprising water and a colorant material to an external surface of a plurality of hydrogel-based materials. The aqueous colorant composition comprises less than 25% (v/v) of an aqueous miscible co-solvent. The hydrogel-based materials comprise a hydrogel matrix encapsulating an active ingredient composition, such as a flavor or fragrance composition. The aqueous colorant composition and the hydrogel-based materials are mixed for a sufficient duration of time to allow substantially all of the aqueous colorant composition to be absorbed into the hydrogel matrix. Optionally, the colored hydrogel-based materials may be dried to remove at least a portion of the water absorbed into the hydrogel matrix thereby leaving the colorant material therein. The resulting colored hydrogel based materials are suitable for use in foodstuffs, such as confectionaries.

### FIELD OF THE INVENTION

The present invention relates to colored hydrogel materials, and more particularly to a method of producing colored hydrogel materials containing active ingredients.

### BACKGROUND OF THE INVENTION

A common process for preparing colored or tinted hydrogel materials involves mixing a colorant into a hydrogel premix, where the colorant becomes fixed within the hydrogel matrix upon effecting gelation. Typically, the gelation process involves heat-treating the hydrogel premix to elevated temperatures for a period of time, followed by cooling below a threshold gelation temperature. For example, gelatin products, such as capsules or beads, are typically heated to about 70° C., before cooling to about 10° C.

While most food grade colorants (synthetic or natural) are thermally stable, some colorants are not. And thus colorants having inherent thermal instabilities under the requisite processing conditions can lead to degradation or changes in the desired color characteristics. Accordingly, some thermally unstable colorants are not suitable for making colored hydrogel materials using the common method described above.

Additionally, since the dye is homogenously dispersed throughout the hydrogel matrix, another drawback to incorporating colorants into the hydrogel premix is the larger amount of dye necessary to impart the desired color appearance parameters, such as hue, colorfulness, saturation, lightness, brightness, and/or chroma. And while the requisite dye content is higher for imparting the desired color appearance, the amount of dye ingested by the consumer is consequentially higher as well.

U.S. Pat. No. 3,394,983 to Grief et al. and U.S. Pat. No. 3,333,031 to Vincent Jr. et al. describe methods for making surface-dyed soft gelatin capsules by applying a 25% to 90% non-toxic water-miscible volatile organic solvent-water solution of a non-toxic dye to the surfaces of premade soft gelatin capsules. While these surface dyeing methods reduce the overall amount of dye consumed to color the capsules, the methods also utilized specially designed equipment and large quantities of volatile organic solvents.

In view of the foregoing, new methods are needed for imparting color to hydrogel materials.

### SUMMARY OF THE INVENTION

Certain aspects of the present disclosure are described in the appended claims. There are additional features and advantages of the subject matter described herein. They will become apparent as this specification proceeds. In this regard, it is to be understood that the claims serve as a brief summary of varying aspects of the subject matter described herein. The various features in the claims and described below for various embodiments may be used in combination or separately. For example, specified ranges may be inclusive of their recited endpoints, unless explicitly excluded. Any particular embodiment need not provide all features noted above, nor solve all problems or address all issues noted above.

The present invention is premised on the realization that a desired color appearance parameter can be imparted to a hydrogel matrix by effecting a partial hydration of the hydrogel matrix with an aqueous colorant composition. This desired color may be imparted without detrimentally affecting the integrity of the hydrogel matrix or its active ingredients, such as flavor and/or fragrance ingredients, contained therein.

Thus, in accordance with an embodiment of the present invention, a method for making colored hydrogel-based materials is provided. The method includes applying an aqueous colorant composition comprising water and a colorant material to an external surface of a plurality of hydrogel-based materials. The aqueous colorant composition comprises less than 25% (v/v) of an aqueous miscible co-solvent. The hydrogel-based materials comprise a hydrogel matrix based on a gelling agent selected from the group consisting of gelatin, pectin, alginate, casein, gellan gum, carrageenan, agar, pullulan gum, and combinations thereof, which encapsulates one or more active ingredients, such as flavor or fragrance ingredients. The method further includes mixing the plurality of hydrogel-based materials for a sufficient duration of time to allow substantially all of the aqueous colorant composition to be absorbed into the hydrogel matrix; and optionally drying the colored hydrogel-based materials at a temperature sufficient to remove at least a portion of the water absorbed into the hydrogel matrix thereby leaving the colorant material therein.

In accordance with another embodiment of the present invention, a colored hydrogel-based material is provided. The colored hydrogel-based material comprises a hydrogel matrix comprising a gelling agent selected from the group consisting of gelatin, pectin, alginate, casein, gellan gum, carrageenan, agar, pullulan gum, and combinations thereof, and one or more active ingredients, such as flavor or fragrance ingredients. A colorant material is inhomogeneously dispersed and absorbed into a surface of the hydrogel matrix, whereby a higher concentration of the colorant material is present near the surface. In an embodiment, the colorant material is a thermally-unstable colorant. In another embodiment, the colored hydrogel matrix is substantially void of any residual aqueous miscible co-solvents.

The objects and advantages of the present invention will be further appreciated in light of the following detailed description and examples.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention. It will be appreciated that for purposes of clarity and where deemed appropriate, reference numerals have been repeated in the figures to indicate corresponding features.

FIG. 1 is a flow chart for illustrating a method of making a colored hydrogel-based material comprising a hydrogel matrix and a fragrance or flavor composition, in accordance with an embodiment of the present invention;

FIG. 2A is a cross-sectional view of prior art, non-dyed, hydrogel-based material having an outer shell of a hydrogel matrix and an inner core containing a mono-phasic fragrance or flavor composition;

FIG. 2B is a cross-sectional view of prior art, non-dyed, hydrogel-based material having an outer shell of a hydrogel matrix and an inner core containing a biphasic fragrance or flavor composition;

FIG. 2C is a cross-sectional view of prior art, non-dyed, hydrogel-based material having an hydrogel matrix containing a fragrance or flavor composition dispersed therein;

FIG. 3A is a cross-sectional view of an inventive hydrogel-based material having an outer shell of a colored hydrogel matrix and an inner core containing a mono-phasic fragrance or flavor composition, where the outer shell has been colored with a colorant material, in accordance with an embodiment of the present invention;

FIG. 3B is a cross-sectional view of an inventive hydrogel-based material having an outer shell of a colored hydrogel matrix and an inner core containing a biphasic fragrance or flavor composition, where the outer shell has been colored with a colorant material, in accordance with an embodiment of the present invention;

FIG. 3C is a cross-sectional view of an inventive hydrogel-based material having a colored hydrogel matrix containing a fragrance or flavor composition dispersed therein, in accordance with an embodiment of the present invention;

FIG. 4 shows photographs of various gelatin-based, seamless capsules, where a) shows uncolored capsules; b) shows gray-colored capsules made by co-extruding a spirulina-containing gellable mixture at 85° C.; c) shows blue/gray-colored capsules made by co-extruding a spirulina-containing gellable mixture at 65° C.; d) shows blue-colored capsules made in accordance with an embodiment of the present invention.

### DETAILED DESCRIPTION OF THE INVENTION

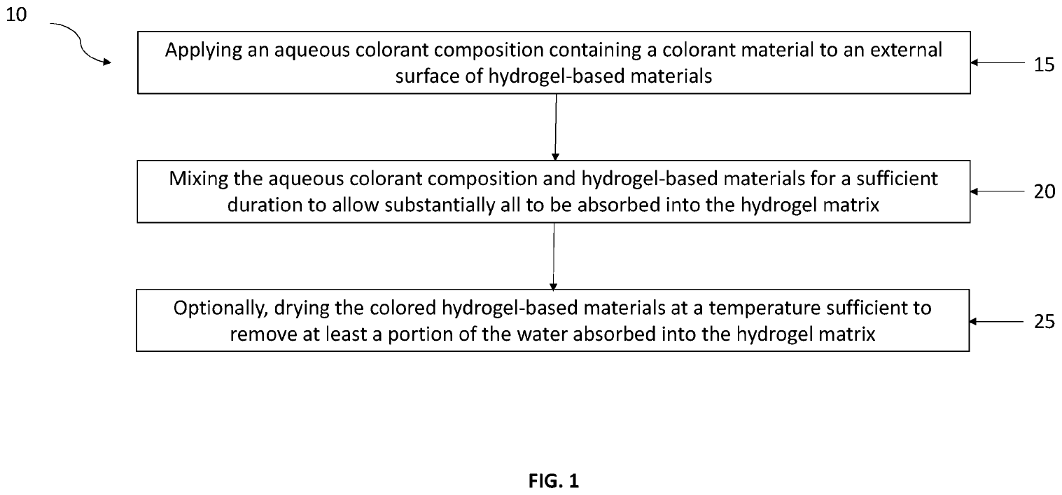

In accordance with embodiments of the present invention, and as represented in FIG. 1, a method 10 for making colored hydrogel-based materials is provided. The method 10 includes applying an aqueous colorant composition comprising water and a colorant material to an external surface of a plurality of hydrogel-based materials (Step 15). The hydrogel-based materials comprise a hydrogel matrix based on a gelling agent selected from the group consisting of gelatin, pectin, alginate, casein, gellan gum, carrageenan, agar, pullulan gum, and combinations thereof, and one or more active ingredients, such as flavor and/or fragrance ingredients. The method further includes mixing the aqueous colorant composition and the hydrogel-based materials for a sufficient duration of time to allow substantially all of the aqueous colorant composition to be absorbed into the hydrogel matrix (Step 20); and optionally drying the colored hydrogel-based materials at a temperature sufficient to remove at least a portion of the water absorbed into the hydrogel matrix thereby leaving the colorant material therein (Step 25).

As used herein, “colorant material” means a colored substance that upon absorption or impregnation into a hydrogel matrix imparts color thereto. The colorant material may include botanical extracts, botanical juices, as well as food grade dyes or pigments, along with chelating agents, stabilizers, or other additives. In accordance with embodiments of the present invention, the colorant material is capable of being incorporated into an aqueous solution, a suspension, or an emulsion, which is suitable for use to impregnate color into the hydrogel matrices described herein.

As used herein, “uncolored” or “non-dyed” are used interchangeably and mean that substantially no colorant has been intentionally added to the hydrogel matrix. These terms do not preclude some color imparted by other functional ingredients, such as gelling agents, fillers, opacifying agents, etc.

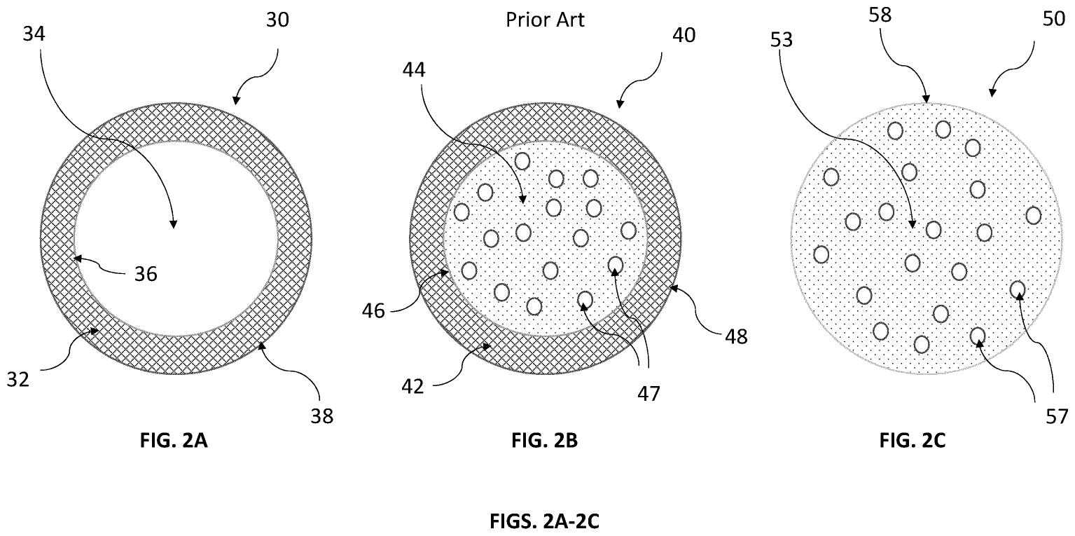

The hydrogel-based materials contain one or more active ingredients, such as flavor or fragrance ingredients, within or surrounded by a gelled matrix. With reference to FIGS. 2A-2C, exemplary and non-limiting examples of flavor and/or fragrance containing hydrogel-based materials of the prior art are shown. These hydrogel-based materials are suitable substrates for employing the color-imparting embodiments of the invention disclosed and described herein. In FIG. 2A, a cross-sectional view of a prior art, non-dyed, hydrogel-based material 30 is shown having an outer shell 32 of a hydrogel matrix and an inner core 34 containing a mono-phasic fragrance or flavor composition (e.g., a seamless capsule). The inner surface 36 and the outer surface 38 of the shell 32 is substantially void of any colorants. In FIG. 2B, a cross-sectional view of a prior art, non-dyed, hydrogel-based material 40 is shown having an outer shell 42 of a hydrogel matrix and an inner core 44 containing a biphasic fragrance or flavor composition 47 interspersed therein (e.g., an encapsulated bead). The inner surface 46 and the outer surface 48 of the shell 42 is substantially void of any colorants. In FIG. 2C, a cross-sectional view of a prior art, non-dyed, hydrogel-based material 50 having a hydrogel matrix 53 containing a fragrance or flavor composition 57 dispersed therein (e.g., a gelled bead). The outer surface 58, as well as the rest of the hydrogel matrix 53 is substantially void of any colorants.

Hydrogel Matrix

In accordance with embodiments of the present invention, the hydrogel matrix of the hydrogel-based material is derived from an aqueous gellable mixture comprising one or more primary hydrocolloid gelling agents selected from hydrophilic polymers that are dispersible in water. The primary hydrocolloid gelling agents are selected from the group consisting of gelatin, pectin, alginate, casein, gellan gum, carrageenan, agar, pullulan gum, and combinations thereof. In an embodiment, the primary hydrocolloid gelling agent comprises gelatin, gellan gum, or a combination thereof.

Non-limiting examples of suitable gelatins include hydrolysates of collagen from bovine (e.g., Geliko® kosher gelatin, Gelita AG), porcine (e.g., D-8 Quick Set 250 Bloom type A, PB Leiner USA), or fish sources (e.g., GAL/F 10-28, Lapi Gelatin). Notably, non-animal based gelatin obtained by fermentation, such as Geltor® (by Geltor, Inc.), may be considered.

Non-limiting examples of suitable pectins include polymers which typically consist mainly of galacturonic acid and galacturonic acid methyl ester units forming linear polysaccharide chains. Typically these polysaccharides are rich in galacturonic acid, rhamnose, arabinose and galactose, for example the polygalacturonans, rhamnogalacturonans and some arabinans, galactans and arabinogalactans. These are normally classified according to the degree of esterification. In high (methyl)ester (“HM”) pectin, a relatively high portion of the carboxyl groups occur as methyl esters, and the remaining carboxylic acid groups in the form of the free acid or as its ammonium, potassium, calcium or sodium salts; useful properties may vary with the degree of esterification and with the degree of polymerization. Pectin in which less than 50% of the carboxyl acid units occur as the methyl ester is normally referred to as low (methyl)ester or LM-pectin. In general, low ester pectin is obtained from high ester pectin by a treatment at mild acidic or alkaline conditions. Amidated pectin is obtained from high ester pectin when ammonia is used in the alkaline de-esterification process. In this type of pectin some of the remaining carboxylic acid groups have been transformed into the acid amide. The useful properties of amidated pectin may vary with the proportion of ester and amide units and with the degree of polymerization. Exemplary pectins include Genu® LM 12CG-Z from CP Kelco U.S., Inc. (Atlanta, Ga.).

Non-limiting examples of suitable alginates include naturally occurring polysaccharides derived from the cell wall of different species of brown algae composed of D-mannuronic acid (M block) and L-guluronic acid (G block). A wide variety of brown seaweeds of the phylum Phaeophyceae are harvested throughout the world to be converted into the raw material commonly known as sodium alginate. Alginate is both food and skin safe. Alginates from different species of brown seaweed often have variations in their chemical structure, resulting in different physical properties. Commercial varieties of alginate are extracted from seaweed, including the giant kelp Macrocystis pyrifera, Ascophyllum nodosum, and various types of Laminaria. According to some embodiments, the alginate is selected from alginic acid, an ester of alginic acid, an alginate salt and combinations thereof. In an embodiment, the ester of alginic acid can include polypropylene glycol alginate (PGA). The alginate salt can be selected from the group consisting of sodium, potassium, and ammonium salts, and combinations thereof. In an embodiment, the chemical compound alginate salt is the sodium salt of alginic acid. Exemplary alginates include TICA-Algin® 400 powder from TIC Gums, Inc. (White Marsh, Md.).

Non-limiting examples of suitable caseins include the predominant phosphoprotein in non-human mammals milk, which comprises the subgroups (also referred to hereinbelow as monomers) αS1, αS2, β (beta) and K (kappa). Accordingly, in some embodiments, the casein is formed from casein monomers, whereby the casein monomers can be one or more of beta casein, kappa casein and alpha casein. In some embodiments, the casein is formed from beta-casein (also referred to herein β-casein or β-CN) monomers. β-casein (β-CN), one of the four main caseins, is a protein that has a well defined hydrophilic N-terminal domain and a hydrophobic C-terminal domain, which renders it highly suitable in the context of embodiments of the invention.

Non-limiting examples of suitable gellans include gellan gum, which is a water-soluble anionic polysaccharide produced by Pseudomonas elodea. Gellan gum comprises repeating units of tetrasaccharide monomers, that include two residues of D-glucose and one of each residues of D-glucuronic acid and L-rhamnose. Exemplary gellan gum includes Kelcogel® gellan gum (CP Kelco).

Non-limiting examples of suitable carrageenans include a polysaccharide extracted from red algae. To form a gel based on kappa carrageenan requires the presence of certain cations, for example potassium ions; Gels based on kappa carrageenan are thermoreversible. The viscosity of a carrageenan solution increases exponentially with the concentration of carrageenan; it is also dependent on the carrageenan type. Exemplary carragheenans include Kappa Carrageenan (e.g., Gelcarin 812, FMC BioPolymer); Iota Carrageenan (e.g., Gelcarin 379, FMC BioPolymer).

Non-limiting examples of suitable agars include polysaccharides derived from red algae.

Non-limiting examples of suitable pullulan gums include linear carbohydrate biopolymers consisting of repeating units of maltotriose joined by α-D28 (1→6) linkages, creating a long stair-step-type structures. Pullulan is a natural extracellular polysaccharide excreted by the black yeast-like fungus Aureobasidium pullulans and by several other non-toxigenic strains of fungi during fermentation of a carbohydrate containing substrate.

In addition to one or more of the recited gelling agents (i.e., gelatin, pectin, alginate, casein, gellan gum, carragheenan, agar, pullulan gum), the gellable mixture may also include one or more other polysaccharide based gelling agents. Exemplary other polysaccharide based gelling agents include, but are not limited to, xanthan gum, arabic gum, tara gum, ghatti gum, karaya gum, dextran, curdlan, welan gum, rhamsan gum, modified starches, or combinations thereof.

In an embodiment, the hydrocolloid gelling agent(s) comprises a polysaccharide based gelling agent bearing carboxylic or carboxylate groups, where upon exposure to cationic crosslinking agents (e.g., mono or multivalent metal ions), crosslinking bridges are formed between inter- and intra-strand carboxylate groups.

Based on a total mass of the dry weight ingredients, the gelling agent(s) may be present in the aqueous gellable matrix in an amount in the range from about 0.1 wt % to about 90 wt %. For example, the gelling agent may be present in the gellable matrix in an amount of 0.1 wt %, 0.2 wt % 0.5 wt %, 0.8 wt %, 1.0 wt %, 1.5 wt % 1.8 wt %, 2.0 wt %, 2.5 wt %, 3.0 wt %, 3.5 wt %, 4.0 wt %, 4.5 wt %, 5.0 wt %, 10 wt %, 15 wt %, 20 wt %, 25 wt %, 30 wt %, 35 wt %, 40 wt %, 45 wt %, 50 wt %, 55 wt %, 60 wt %, 90 wt %, or in a range between any two of the foregoing.

In an embodiment, the hydrocolloid gelling agent comprises gelatin, and the gelatin may be present in an amount from 10 to 90 wt %, such as in an amount of 10 wt %, 20 wt %, 30 wt %, 40 wt %, 50 wt %, 60 wt %, 70 wt %, 80 wt %, 90 wt %, or in a range between any two of the foregoing. In another embodiment, the hydrocolloid gelling agent comprises gelatin and pectin, where a weight ratio between the gelatin and the pectin is in a range from 5:1 to 50:1, such as 5:1, 8:1, 10:1, 15:1, 20:1, 25:1, 30:1, 35:1, 40:1, 45:1, 50:1, or in a range between any two of the foregoing. In another embodiment, the hydrocolloid gelling agent comprises gelatin and alginate, where a weight ratio between the gelatin and the alginate is in a range from 5:1 to 50:1, such as 5:1, 8:1, 10:1, 15:1, 20:1, 25:1, 30:1, 35:1, 40:1, 45:1, 50:1, or in a range between any two of the foregoing. In another embodiment, the hydrocolloid gelling agent comprises gelatin and casein, where a weight ratio between the gelatin and the casein is in a range from 5:1 to 50:1, such as 5:1, 8:1, 10:1, 15:1, 20:1, 25:1, 30:1, 35:1, 40:1, 45:1, 50:1, or in a range between any two of the foregoing. In another embodiment, the hydrocolloid gelling agent comprises gelatin and gellan, where a weight ratio between the gelatin and the gellan is in a range from 5:1 to 50:1, such as 5:1, 8:1, 10:1, 15:1, 20:1, 25:1, 30:1, 35:1, 40:1, 45:1, 50:1, or in a range between any two of the foregoing. In another embodiment, the hydrocolloid gelling agent comprises gelatin and carragheenan, where a weight ratio between the gelatin and the carragheenan is in a range from 5:1 to 50:1, such as 5:1, 8:1, 10:1, 15:1, 20:1, 25:1, 30:1, 35:1, 40:1, 45:1, 50:1, or in a range between any two of the foregoing. In yet another embodiment, the hydrocolloid gelling agent comprises gelatin and one or more of the additional polysaccharide based gelling agents, where a weight ratio between the gelatin and the polysaccharide based gelling agent(s) is in a range from 5:1 to 50:1, such as 5:1, 8:1, 10:1, 15:1, 20:1, 25:1, 30:1, 35:1, 40:1, 45:1, 50:1, or in a range between any two of the foregoing.

Filler

In an aspect of the invention, the gellable mixture may further comprise a filler, which may be a material that can increase the percentage of dry material in the gelled matrix. In an aspect, the filler may further act as an antiplasticizer making the breakable shell physically more resistant to deformation or breakage. In another aspect, the filler may further act as a plasticizer, which improves the processability of the gellable mixture and/or the flexibility of the gelled matrix. Exemplary fillers may include, but are not limited to starch derivatives such as partially-gelatinized high-amylose starch, dextrin, maltodextrin, innulin, sucrose, allulose, tagatose, cyclodextrin (alpha, beta, gamma, or modified cyclodexrin); cellulose derivatives such as microcrystalline cellulose (MCC) hydroxypropylmethyl cellulose (HPMC), hydroxypropylcellulose (HPC), methylcellulose (MC), or carboxy-methylcellulose (CMC); a polyvinyl alcohol; polyols with non-plasticizing properties; trehalose; erythritol; maltitol; mannitol; xylitol; glycerol; triacetine; a polyethylene glycol, polyols with plasticizing or humectant properties; or combinations of two or more of the foregoing. For example, in an embodiment the filler is selected from the group consisting of sorbitol, glycerol, mannitol, sucrose, trehalose, propylene glycol, xylitol, erythritol, and combinations thereof. Based on a total mass of the dry weight ingredients, the filler may be present in the gellable matrix in an amount in the range from about 0.1 to about 60 wt %. For example, the filler may be present in the gellable matrix in an amount of 0.1 wt %, 0.2 wt % 0.5 wt %, 0.8 wt %, 1.0 wt %, 1.5 wt % 2.0 wt %, 2.5 wt %, 3.0 wt %, 4.0 wt %, 5.0 wt %, 7.5 wt %, 10 wt %, 12.5 wt %, 15 wt %, 17.5 wt %, 20 wt %, 25 wt %, 35 wt %, 45 wt %, 50 wt %, 60 wt %, or in a range between any two of the foregoing. In an embodiment, the gellable matrix comprises 85 to 93 wt % gelatin and 7 to 15 wt % sorbitol, based on a total mass of the dry weight ingredients.

The hydrogel matrix of the hydrogel-based materials are derived from an aqueous gellable mixture. Accordingly, the gellable mixture comprises an aqueous mixture of the hydrocolloid gelling agent(s), filler, etc. in water. A typical weight ratio of water to the non-water (dry) ingredients is in a range from 1:1 to 20:1. Preferably, the water used for the external phase is purified water, such as distilled water, deionized water, or reverse osmosis water, but processing (tap) water is viable. If processing water, which may contain alkali or alkaline earth metal salts, is used with an alginate or an acid polysaccharide hydrocolloid gelling agent (e.g., gellan gum), a sequestering or complexing agent, may be added to the gellable mixture to minimize untimely or uncontrollable gelling. The amount of sequestering agent is at most 2 wt %, preferably at most 1 wt % and even more preferably at most 0.5 wt %, wherein wt % is based on the total dry weight of the shell ingredients. The sequestering agent may comprise a salt, preferably selected from the group comprising trisodium citrate, trisodium phosphate, tetrasodium pyrophosphate, sodium hexametaphosphate, and mixtures thereof.

In this particular embodiment employing the use of the sequestering agent in the gellable mixture, the uncrosslinked surface region of the gelled matrix may be treated with a curing solution that comprises one or more crosslinking agents once the gelled matrix is formed. For example a cation containing salt in the composition, which serves to enhance the setting ability of the gelling agents. Preferably, the salt comprises cations such as K+, Li+, Na+, NH4+, Ca2+, or Mg2+, etc. The amount of cations is less than 5 wt %, preferably less than 3 wt %, more preferably 0.01 wt % to 3 wt %, even more preferably 0.5 wt % to 2 wt %, especially 0.01 to 1 wt %, wherein wt % is based on the dry weight ingredients of the aqueous gellable mixture.

Alternatively, the gellable mixture may further include a cationic crosslinking agent. Exemplary cationic crosslinking agents include a salt, such as salts comprising K+, Li+, Na+, NH4+, Ca2+, Mg2+, or combinations thereof. The concentration of the cationic crosslinking agent in the aqueous gellable mixture may be less than 2 wt %, wherein wt % is based on the dry weight ingredients (e.g., hydrocolloid, filler, etc.) in the gellable mixture. For example, the cationic crosslinking agent may be present in an amount of 0.1 wt %, 0.25 wt %, 0.5 wt %, 0.75 wt %, 0.9 wt %, 1.0 wt %, 1.1 wt %, 1.25 wt %, 1.50 wt %, 1.75 wt %, 1.9 wt %, 2.0 wt %, or in a range between any two of the foregoing. Variations in the amount of cationic crosslinking agent, relative to the amount of reactive gelling agent, provides an aspect for tuning the viscosity of the gellable matrix and the texture properties of the gelled matrix.

The gellable mixture can also further include preservatives or bactericides such as benzoate, parabens, diols, cetylpyridinium chloride, diazolidinyl urea or any preservatives used for food, pharmaceutical or cosmetic products. Such preservatives may be useful if the hydrogel-based materials are not sufficiently dried to inhibit growth of bacteria, molds, and yeasts (i.e., a water activity (Aw) equal to 0.6 or less). Water activity (Aw), as known by one skilled in the art, is sometimes referred to as “free” or “available” water in a system that is not bound to non-aqueous constituents. It can properly be defined as the partial vapor pressure of food moisture divided by the equilibrium vapor pressure of pure water at the same temperature. Water activity value can be measured using a LabMaster-aw by Novasina AG (Lachen, Switzerland), at 25° C.

Active Ingredients

In accordance with embodiments of the present invention, the hydrogel-based materials comprise one or more active ingredients. The active ingredients may contain a variety of different substances such as preservatives, antioxidants, diluents, sugars, sugar substitutes, sugar alcohols, sweeteners, consumable acids, dyes, colorants, pigments, flavor enhancers, flavorings, flavors, essential oils, cooling and/or refreshing substances, nutraceuticals, pharmaceutically active substances, antimicrobial agents, anti-inflammatory substances, tooth-care substances, enzymes, pH regulators, trace elements, minerals, vitamins, fatty oils, silicone oils, fats, diluents or herbal extracts. In accordance with an embodiment, the hydrogel-based materials comprise one or more flavor or fragrance compositions, which may include natural or synthetic aromas and/or fragrances. Non-limiting examples of suitable fragrances are fruity, confectionery, floral, sweet, woody fragrances. Examples of suitable aromas are vanilla, coffee, chocolate, cinnamon, mint.

The flavor composition used according to the invention comprises lipophilic or amphiphilic flavor substances. Lipophilic flavoring substances are preferably used in the context of the present invention and thus encapsulated within the hydrogel-based material. Non-limiting examples of suitable flavorings substances include peppermint oils, spearmint oils, eucalyptus oils, wintergreen oils, cinnamon oils, cassia oils, aniseed oils, bitter almond oils, clove oils, parsley seed oils, citrus oils, vanilla (extracts), fruity flavoring compositions having tastes oriented towards, for example, apple, pear, peach, grape, strawberry, raspberry, cherry, or pineapple are preferably used.

The flavoring substances belong to various chemical groups, such as the group comprising hydrocarbons, aliphatic alcohols, aliphatic aldehydes and the acetals thereof, aliphatic ketones and oximes thereof, aliphatic sulfur-containing compounds, aliphatic nitriles, aliphatic carboxylic acids esters, acyclic terpene alcohols, acyclic terpene aldehydes and ketones, cyclic terpene alcohols, cyclic terpene aldehydes and ketones, cyclic alcohols, cycloaliphatic carboxylic acids, aromatic hydrocarbons, araliphatic alcohols, esters of araliphatic alcohols and aliphatic carboxylic acids, araliphatic ethers, aromatic and araliphatic aldehydes, aromatic and araliphatic ketones, aromatic and araliphatic carboxylic acids and the esters, nitrogenous aromatic compounds, phenols, phenyl ethers, phenyl esters heterocyclic compounds, lactones, and combinations thereof.

The flavoring substances are preferably selected from the group consisting of: acetophenone, allyl capronate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymol, damascone, decalactone, dihydrocoumarin, dimethyl anthranilate, dimethyl anthranilate, dodecalactone, ethoxyethyl acetate, ethylbutyric acid, ethyl butyrate, ethyl caprinate, ethyl capronate, ethyl crotonate, ethyl furaneol, ethyl guajacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. hedione), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl capronate, trans-2-hexenyl capronate, cis-3-hexenyl formate, cis-2-hexyl acetate, cis-3-hexyl acetate, trans-2-hexyl acetate, cis-3-hexyl formate, para-hydroxy benzyl acetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methylbutyric acid, 2-methylbutyl acetate, methyl capronate, methyl cinnamate, 5-methyl furfural, 3,2,2-methyl cyclopentenolone, 6,5,2-methyl heptenone, methyl dihydrojasmonate, methyl jasmonate, 2-methyl methyl butyrate, 2-methyl-2-pentenoic acid, methylthiobutyrate, 3,1-methylthiohexanol, 3-methylthiohexyl acetate, nerol, neryl acetate, trans,trans,2,4-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovalerate, piperonal, propionaldehyde, propyl butyrate, pulegone, pulegol, sinensal, sulfurol, terpinene, terpineol, terpinolene, 8,3-thiomenthanone, 4,4,2-thiomethyl pentanone, thymol, delta-undecalactone, gamma-undecalactone, valencene, valeric acid, vanillin, acetoin, ethyl vanillin, ethyl vanillin isobutyrate, 2,5-dimethyl-4-hydroxy-3(2H)-furanone, homofuraneol, homofuronol, 5-ethyl-2-methyl-4-hydroxy-3(2H)-furanone, maltol and maltol derivatives, coumarin and coumarin derivatives, gamma-lactones, gamma-undecalactone, gamma-nonalactone, gamma-decalactone, delta-lactones, 4-methyl delta decalactone, massoia lactone, delta decalactone, tuberose lactone, methyl sorbate, divanillin, 4-hydroxy-2 (or 5)-ethyl-5 (or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methylbutyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenyl glycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenyl-acetaldehyde, 2-methyl-3-(methylthio)furan, 2-methyl-3-furanthiol, bis(2-methyl-3-furyl)disulfide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, mercapto-3-methyl-1-butanol, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guajacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol and further stereoisomers, enantiomers, positional isomers, diastereomers, cis/trans-isomers or epimers (not expressly mentioned) of these substances.

For the purpose of the present invention the flavoring substances may be divided into three groups, depending upon their log K_{o/w} and namely so, that each group is associated with a degree of difficulty for encapsulation of the respective flavor substance.

Flavoring substances with a log K_{o/w}≥2 are lipophilic compounds, which are quite easy to encapsulate. In an embodiment, a seamless capsule form of the hydrogel-based materials can include in the core more than 50 wt % and up to 95 wt % of flavor substances with a log K_{o/w}≥2, based upon the total mass of the capsule. Exemplary lipophilic flavor substances include, but are not limited to, carvone (log K_{o/w}=2.23), gamma-decalactone (log K_{o/w}=2.42), ethyl-caproate (log K_{o/w}=2.83), linalool (log K_{o/w}=3.28) and beta-pinene (log K_{o/w}=4.37).

Flavoring substances with a log K_{o/w} between 1 and 2 can be considered as amphiphilic compounds and are comparatively more difficult to encapsulate. In an embodiment, a seamless capsule form of the hydrogel-based materials can include in its core at least 10 wt % and up to 50 wt % of flavor substances with a log K_{o/w} between 1 and 2, based upon the total mass of the capsule. In the second group of flavor substances there are substances such as ethyl butyrate (log K_{o/w}=1.77), benzaldehyde (log K_{o/w}=1.64), isoamyl alcohol (log K_{o/w}=1.28), ethyl propionate (log K_{o/w}=1.24) and diacetyl (butanedione) (log K_{o/w}=1.33).

Flavoring substances with a log K_{o/w}≤1 are amphiphilic to hydrophilic substances and are particularly difficult to encapsulate. In an embodiment, a seamless capsule form of the hydrogel-based materials can include in its core up to 10 wt % of flavor substances with a log K_{o/w}≤1, based upon the total mass of the capsule. In this third group of flavor substances there are substances such as ethyl lactate (log K_{o/w}=0.88), anisaldehyde (log K_{o/w}=0.95), butyric acid (log K_{o/w}=0.78), ethylacetate (log K_{o/w}=0.75).

In an embodiment, the flavoring substance contained in dissolved or dispersed form in the core or hydrogel matrix of the hydrogel-based material may contain 10 wt % or more, based upon the total mass of the flavor composition, of one or more flavor substances with a log K_{o/w}<2. If the flavoring substance is present in the core in dissolved form (e.g., mono-phasic), then the proportion of flavor substances with a log K_{o/w}<1 should however be maintained as small as possible in order to prevent unacceptable flavor losses and preferably not more than 1 wt. %, based upon the total mass of the flavor. When the flavor in the hydrogel-based material is in dispersed form, for example a biphasic form, then the propensity for partitioning of flavor substances into the hydrogel matrix (e.g., capsule shell) may be reduced in comparison to a dissolved flavor, so that also one or more flavor substances with a log K_{o/w}<1.0 can be contained in the flavor, for example in the range of 0.5 to 3.0 wt. % based upon the total mass of the flavor in hydrogel-based material.

In addition, suitable individual substances as part of the flavorings substance are those having a cooling refreshing effect in the throat or in the oral or nasal cavity. Non-limiting examples include menthol, menthone, menthone glycerin acetate, menthyl acetate, menthyl methyl ether, methone acetals, menthol carbonates, menthyl lactate, menthyl succinates (such as monomenthyl succinate sold under the tradename PHYSCOOL®), substituted menthyl-3-carboxamides (for example menthyl-3-carboxylic acid-N-ethylamide), 2-isopropyl-N-2,3-trimethylbutanamide, substituted cyclohexane carboxamides, 3-menthoxypropane-1,2-diol, 2-hydroxyethyl menthyl carbonate, 2-hydroxypropyl menthyl carbonate, N-acetylglycine menthyl ester, isopulegol, hydroxycarboxylic acid menthyl esters (for example menthyl-3-hydroxybutyrate), 2-mercaptocyclodecanone, menthyl-2-pyrrolidin-5-onecarboxylate, 2,3-dihydroxy-p-menthane, 3,3,5-trimethylcyclohexanone glycerol ketal, 3-menthyl-3,6-di- and -tri-oxaalkanoates, 3-menthyl methoxyacetate, icilin, 1,8-cineol (eucalyptol), carvone, alpha-terpineol, thymol, methyl salicylate, 2′-hydroxypropiophenone, or a combination of two or more of the foregoing.

The flavor composition may also comprise one or more sweeteners, with the use of solubilizing agents, if appropriate. In general, applicable sweeteners include saccharin (optionally as sodium, potassium, or calcium salt), aspartame, cyclamate (optionally as sodium or calcium salt), acesulfam-K, neohesperidin dihydrochalcone. Furthermore, other sweeteners, such as steviols, stevioside, rebaudioside A, glycyrrhizin, osladin, brazzein, miraculin, pentadin, phyllodulcin, dihydrochalcone, arylureas, trisubstituted guanidines, glycyrrhizin, superaspartam, suosan, sucralose (trichlorogalactosesucrose or TGS), alitame, monellin, as well as other natural or artificial sweeteners may also be used.

The hydrogel-based materials comprising the encapsulated flavor and/or fragrances may be formed by methods commonly performed in the art. Non-limiting examples include co-extrusion, drop method, or simple or complex coacervation, emulsified and poured into a form, etc. In accordance with embodiment, the hydrogel-based material may be spherically shaped (e.g., a capsule or bead). Non-limiting examples include the hydrogel based materials shown in FIGS. 2A-2C. Once the hydrogel-based material comprising the encapsulated fragrance and/or flavor composition is formed and the excess water removed from the hydrogel matrix to an acceptable level of dryness (or water activity), the uncolored hydrogel-based material is ready for coloring. For example, the water content of the hydrogel based materials may be about 25 wt % or less, such as 25 wt %, 20 wt %, 15 wt %, 10 wt %, 9 wt %, 8 wt %, 7 wt %, 6 wt %, 5 wt %, 4 wt %, 3 wt %, 2 wt %, 1 wt %, or in a range between any two of the foregoing, wherein wt % is based on the weight of the hydrogel-based material. Dessicant materials, such as silica or starch, may be used to facilitate drying of the uncolored hydrogel-based material, as well as inhibit clumping or aggregation thereof.

In accordance with embodiments of the present invention, an aqueous colorant composition comprising water and a colorant material is applied to the external surface of the uncolored hydrogel-based materials. The aqueous solution, dispersion, or emulsion of the colorant material is applied in a manner to evenly distribute the quantity over the materials. In an embodiment, the hydrogel-based materials may be agitated or mixed concurrently with the application of the colorant material. In an embodiment, the aqueous colorant composition is applied in any suitable manner commonly known in the art, for example by spraying or dosing. In an embodiment, the aqueous colorant composition is applied by spraying in a fluid bed dryer. In another embodiment, the aqueous colorant composition is sprayed or dosed in a pan coater. Without being bound by any particular theory, it is believed that water absorbed at the external surface of the hydrogel matrix migrates into the hydrogel matrix while carrying along the colorant material. Upon evaporation of the water from the hydrated portion, the colorant material remains within the hydrogel matrix to impart color, without substantial detriment to the flavor/fragrance composition contained therein.

Non-limiting examples of colorant materials suitable for use in the embodiments of the present invention comprise water-soluble dyes, or organic soluble dyes. In an embodiment, the colorant material is a synthetic or artificial dye. In another embodiment, the colorant material is a natural colorant. The term “natural colorant” refers to natural ingredients that are exempt from certification by the United States Food and Drug Administration (US FDA) or those colorants approved by the European Food Safety Authority (EFSA). Exemplary natural colorants include, but are not limited to, anthocyanins, chlorophylls, carotenoids, betanin compounds, from botanical sources such as turmeric, carrots, pumpkin, sweet potatoes, saffron, alfalfa, paprika, and the like. Another such natural colorant is a Spirulina extract made from the dried biomass of the cyanobacteria Arthrospira platensis, which contains blue phycocyanins and is FDA approved (21 C.F.R. 73.530) as a natural alternative for artificial FD&C Blue No. 1 in foodstuffs, such as candy and chewing gum. One commercial source of blue phycocyanins derived from Spirulina is Linablue®, which is produced by DIC LIFETEC Co., Ltd. (Tokyo, Japan). Phycocyanins-containing colorants are often spray dried with stabilizers, such as trehalose or other polyols. Trehalose-free formulations are also available, such as Vegebrite® Ultimate Spirulina, produced by Naturex S.A. (Avignon, France). Other natural coloring agents may also be obtained from Kancor Ingredients, Ltd (Kerala, India), including the natural pigments sold under Kancor's C-CAPTURE's color stabilization process. Another natural colorant is EXBERRY® “Cherry Red Powder,” (GNT USA, Inc. GNT Product No. 153901), which is a blend of black carrot and hibiscus concentrates.

In an embodiment, the colorant material comprises a thermally unstable dye, which undergoes a temperature-induced change in a color appearance parameter when subjected to a temperature in excess of a thermal degradation temperature of the colorant material, in the presence or absence of water. The color appearance parameter is selected from the group consisting of hue, colorfulness, saturation, lightness, brightness, and chroma. The thermal degradation temperature of the colorant material, in the presence or absence of water, may be about 40° C., about 45° C., about 50° C., about 55° C., about 60° C., about 65° C., about 70° C., about 75° C., about 80° C., or in a range between any two of the foregoing. The thermal degradation temperature for the colorant material may be empirically determined by evaluating the stability of the dye, under the coloring and/or drying process environment and temperature(s).

The quantity of dye or pigment in the colorant material should be sufficient to impart the desired color appearance parameters, such as hue, colorfulness, saturation, lightness, brightness, and/or chroma. For example, in an embodiment, the mass ratio of the dye or pigment to the hydrogel-based material is about 1:200 to about 1:10, such as 1:200, 1:150, 1:100, 1:50, 1:40, 1:30, 1:20, 1:10, or in a range between any two of the foregoing. For example, in another embodiment, the mass ratio of the colorant material to the hydrogel-based material is about 1:200 to about 1:10, 1:150 to 1:100, or 1:200 to 1:50. The colorant material should be dispersible or soluble in the quantity of water used to apply the aqueous colorant composition.

Preferably, the water used for forming the aqueous colorant composition is purified water, such as distilled water, deionized water, or reverse osmosis water, but processing (tap) water is viable. The quantity of water used to apply the colorant material to the hydrogel-based material should be sufficient to dissolve/suspend the requisite quantity of colorant material, but be limited so as not to detrimentally impact the physical integrity of the hydrogel matrix or its ability to contain the flavor/fragrance composition therein. In an embodiment, the amount of water may be based on the entire mass of the hydrogel-based materials or on the mass of the hydrogel matrix component of the hydrogel-based materials. In an embodiment, a ratio of a mass of the aqueous colorant composition (mass of the water and colorant material) to a mass of the plurality of hydrogel-based materials is within a range of about 1:1 to about 1:19, such as 1:19, 1:17, 1:15, 1:12, 1:10, 1:9, 1:8, 1:7, 1:5, 1:4, 1:3, 1:2, 1:1, or in a range between any two of the foregoing. For example, the ratio of the mass of the aqueous colorant composition to the mass of the plurality of hydrogel-based materials may be within a range of 1:19 to 1:4. In another embodiment, the ratio of the mass of the aqueous colorant composition (mass of the water and colorant material) to a mass of the hydrogel matrix is within a range of about 3:1 to about 1:7, such as 3:1, 5:2, 2:1, 3:2, 1:1, 1:2, 1:3, 1:4, 1:5, 1:6, 1:7, or in a range between any two of the foregoing. For example, the ratio of the mass of the aqueous colorant composition to the mass of the hydrogel matrix may be within a range of 1:1 to 1:3. When the amount of water is too low, the colorant is unequally absorbed and results in spotty, non-uniformly colored hydrogel-based materials. When the amount of water is higher, the hydrogel-based materials can become overly hydrated, and then may agglomerate and stick together. Additionally, the ability of the hydrogel matrix to retain the flavor and/or fragrance composition may be compromised.

In another embodiment, the amount of water may be based on predetermined swelling ratio, which is simply a ratio of the mass of hydrated gel matrix to the mass of the dry gel matrix. Each gelled matrix comprised of hydrocolloid gelling agent(s) and fillers is capable of absorbing a significant quantity of water. The extent of water absorption may be based on a variety of factors, type and amount of hydrocolloid, type and amount of filler, degree of crosslinking of the gel network, as well as temperature, pH, ionic strength, etc. of the water. For example, swelling ratios of 4 to 12 are not uncommon. In accordance with an embodiment, the quantity of water used to apply the colorant material to the hydrogel-based materials is sufficient to achieve a swelling ratio in a range from 0.1 to about 3, such as 0.1, 0.25, 0.5, 0.75, 1, 1.5, 2, 2.5, 3, or in a range between any two of the foregoing.

Without being bound by any particular theory, Applicant believes that excessive amounts of aqueous miscible co-solvents in the aqueous colorant composition can also lead to a loss of fragrance and/or flavor composition. Moreover, certain volatile and/or amphiphilic flavor or fragrance ingredients may be selectively lost, thereby resulting in a change in the retained flavor/fragrance composition. Thus, in accordance with embodiment of the present invention, the aqueous colorant composition comprises less than 25% (v/v) of an aqueous miscible co-solvent. Exemplary aqueous miscible co-solvents include, but are not limited to, C1-C4 alcohols, such as methanol, ethanol, propanol, butanol, propylene glycol, or glycerol, or C3-C4 ketones, such as acetone or methyl ethyl ketone. In an embodiment, the aqueous colorant composition comprises 10% (v/v) or less of the aqueous miscible co-solvent. In another embodiment, the aqueous colorant composition comprises 5% (v/v) or less of the aqueous miscible co-solvent. In another embodiment, the aqueous colorant composition is substantially void of any aqueous miscible co-solvents. As used herein, “substantially void” means that 2 wt % or less of the aqueous miscible co-solvent is present in the aqueous colorant solution. In yet another embodiment, the aqueous colorant composition is void of any aqueous miscible co-solvents that have been intentionally added. Thus, in an embodiment, the aqueous colorant composition is void of ethanol, propanol, butanol, propylene glycol, glycerol, acetone, and/or methyl ethyl ketone. Accordingly, in another embodiment, the aqueous colorant composition consists of water and the colorant material.

After or concurrent with application of the aqueous colorant solution, the treated hydrogel-based materials are mixed or agitated to assist with dispersing or distributing the non-absorbed portion of the aqueous colorant composition to any untreated surfaces. The treated hydrogel-based materials are mixed or agitated for a sufficient duration to allow substantially all of the aqueous colorant composition to be absorbed into the hydrogel matrix. In an embodiment, the application of the aqueous colorant composition and the mixing may be performed concurrently in a pan-coater apparatus or in a fluid bed apparatus.

After the aqueous colorant composition has been substantially absorbed into the hydrogel matrix, the water portion of the absorbed dye solution may be removed from the colored hydrogel-based materials. In an embodiment, the temperature of air flow through the fluid bed apparatus is increased to a temperature sufficient to facilitate removal of the carrier water to the desired extent. The drying process may be conducted at a single temperature (isothermal), or may be varied (e.g., gradual or step-wise). The temperature should not exceed any thermal degradation temperature of the colorant material or the fragrance/flavor composition. In an embodiment, the maximum drying temperature is 80° C. or less, such as 75° C., 70° C., 65° C., 60° C., 55° C., 50° C., 45° C., 40° C., or 35° C., to provide the desired colored hydrogel-based materials having the expected color characteristics and water activity, without substantial changes to the fragrance/flavor composition. In an embodiment, the color-treated capsules are dried under a multi-stage process performed at 35° C. first stage, 40° C. second stage, and 45° C. third stage. The drying process may be conducted under reduced pressure (<760 torr).

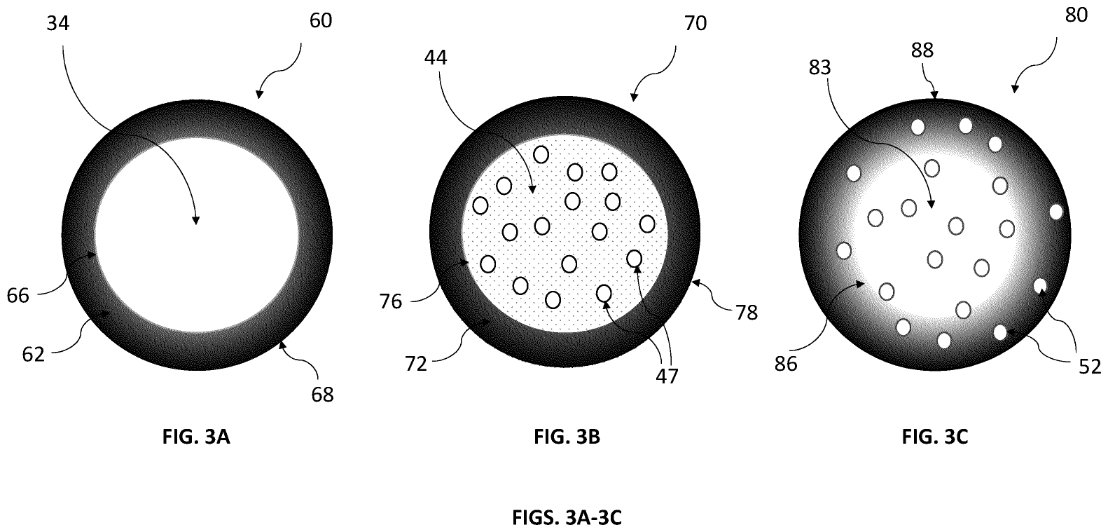

In reference to FIGS. 3A-3C, various embodiments of colored hydrogel-based materials, corresponding to their uncolored variants shown in FIGS. 2A-2C, respectively, are shown. Specific reference to FIG. 3A, following treatment of the uncolored hydrogel-based material 30 shown in FIG. 2A, in accordance to the method described in FIG. 1, a colored hydrogel-based material 60 is provided that comprises a colored outer shell 62 of a hydrogel matrix and an inner core 34 containing a mono-phasic fragrance or flavor composition, which is substantially unchanged by the coloring process. At or near the outer surface 68 of the shell 62, the colorant is more concentrated, relative to the inner surface 66 of the shell 62.

In reference to FIG. 3B, following treatment of the uncolored hydrogel-based material 40 shown in FIG. 2B, in accordance with the method described in FIG. 1, a colored hydrogel-based material 70 is provided that comprises a colored outer shell 72 of a hydrogel matrix and an inner core 44 containing a biphasic fragrance or flavor composition 47, which is substantially unchanged by the coloring process. At or near the outer surface 78 of the shell 72, the colorant is more concentrated, relative to the inner surface 76 of the shell 72.

In reference to FIG. 3C, following treatment of the uncolored hydrogel-based material 50 shown in FIG. 2C, in accordance with the method described in FIG. 1, a colored hydrogel-based material 80 is provided that comprises a colored hydrogel matrix 83 containing a fragrance or flavor composition 52, which is substantially unchanged by the coloring process. At or near the outer surface 88 of the hydrogel matrix 83, the colorant is concentrated, but the colorant concentration decreases further into the matrix until reaching a region 86 that may be substantially void of any colorant.

The colored hydrogel-based materials may be subjected to further processing, such as polishing or being coated with a food grade shellac or other edible barrier material, such as waxes, fatty alcohols, and the like. The colored hydrogel-based materials may be incorporated in foodstuffs, such as confectionaries.

Non-limiting examples of colored hydrogel-based materials, made in accordance with the detailed description, is disclosed below. The examples are merely for the purpose of illustration and are not to be regarded as limiting the scope of the invention or the manner in which it can be practiced. Other examples will be appreciated by a person having ordinary skill in the art.

### EXAMPLES

Exemplary flavor filled seamless capsule form of the hydrogel-based materials may be formed in accordance with general procedures described in U.S. Patent Application Publication Numbers US2009/0304784 or US2009/0208568, or French Patent Application serial numbers FR1872369 or FR1872372, each of which is incorporated herein by reference in its entirety. Upon drying to a sufficient extent, the capsules may be colored with the desired colorant material, in accordance with the embodiments disclosed herein.

A suitable amount of water used to apply the colorant material to the hydrogel-based materials may be empirically determined following the general procedure outlined below. Trial samples of dry gelatin-based seamless capsules (about 1 wt % water) were treated with increasing amount of an aqueous colorant composition (containing about 1 wt % of Linablue® spirulina, where the wt % of the colorant substance is based on the weight of the capsules), mixed, and dried. The uniformity of the color absorption and the physical integrity of the gelatin-based shell was assessed. Table 1 below details the amount water, relative mass ratios, and observations.

TABLE 1
Examples of coloring gelatin-based capsules with spirulina.

| Trial | Water | Capsule | Water:Capsule | Gelatin | Water:gelatin | |
|---|---|---|---|---|---|---|
| # | (wt %) | (wt %) | ratio | (wt %) | ratio | Comments |
| 1 | 1 | 99 | 1:99 | 27.19 | 1:27.2 | Spotty color |
| 2 | 2 | 98 | 1:49 | 26.91 | 1:13.5 | Spotty color |
| 3 | 3 | 97 | 1:32.3 | 26.64 | 1:8.9 | Spotty color |
| 4 | 4 | 96 | 1:24 | 26.36 | 1:6.6 | Spotty color |
| 5 | 5 | 95 | 1:19 | 26.09 | 1:5.2 | Spotty color |
| 6 | 10 | 90 | 1:9 | 24.71 | 1:2.5 | Acceptable color |
| 7 | 15 | 85 | 1:5.7 | 23.34 | 1:1.6 | Acceptable color |
| 8 | 20 | 80 | 1:4 | 21.97 | 1:1.1 | Acceptable color |
| 9 | 25 | 75 | 1:3 | 20.60 | 1:0.8 | Sticky shell, oil |
| | | | | | | leakage |

In a GEA STREA-1™ fluid bed dryer was charged 990 grams of dry (≤3 wt % water) 1 mm gelatin-seamless capsules containing mint flavoring. While fluidizing the capsules at about 30 CFM and 20° C., an aqueous colorant mixture comprising 9.9 grams of Spirulina dye (Linablue® produced by DIC LIFETEC Co., Ltd. (Tokyo, Japan)) dissolved in about 140 grams of water was applied over a 20 minute duration at a spray rate of approximately 7.5 g/min (atomizer pressure 1.5 bar). When all of the aqueous colorant mixture had been sprayed onto and adsorbed by the capsules, the excess water was removed by applying heated air to the fluid bed dryer over three stages. The temperatures of the three stages were 35° C., 40° C., and 45° C., where the first two stages were conducted for 15 minutes each, and the last stage was maintained until the colored capsules reached ≤3 wt % water, based on the entire weight of the capsule. Final moisture content of the dry, colored mint-flavor capsules was 2.3 wt %, with virtually no loss in flavor composition or change in flavor profile.

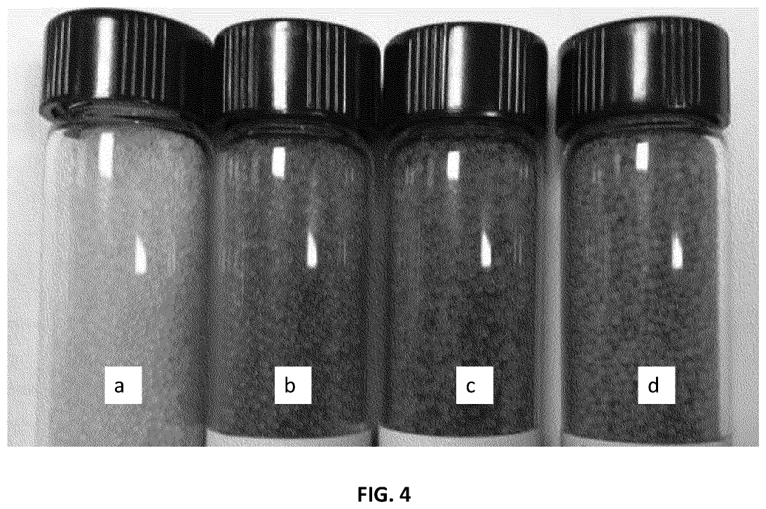

FIG. 4 shows photographs of various gelatin-based, seamless capsules, where a) is uncolored gelatin-based capsules, and b) is gray colored capsules made by co-extruding a phycocyanin-containing (spirulina) gellable mixture at 85° C. Under the elevated temperature, the blue color of the phycocyanin thermally decomposed to gray. Similarly, c) is blue-gray colored capsules made by co-extruding a phycocyanin-containing (spirulina) gellable mixture at 65° C. While the extent of thermal degradation was less at 65° C. than at 85° C., the conditions for co-extrusion proved to unsatisfactory for making blue phycocyanin capsules. FIG. 4 d) shows blue colored capsules made by impregnating the uncolored capsule in a) with an aqueous phycocyanin-containing (spirulina) solution, in accordance with an embodiment of the present invention.

Three additional examples of seamless capsules were colored with two natural colorants, where the capsules were 1.2 mm gellan-based seamless capsule, dried, 23 wt % film, menthol flavor core; 2.5 mm gelatin-based seamless capsule, dried, 27 wt % film, unflavored (medium chain triglyceride) core; and 1 mm gellan/HAS-based seamless capsules, dried, 27 wt % film, spearmint flavor core, and the two colorants were Linablue® spirulina (blue) and EXBERRY® “Cherry Red” Powder GNT Product No. 153901 (red). Water and dye quantities were varied to determine optimum amounts to provide uniform color without overhydrating the shells. Details for those trials (10-20) are shown in Table 2.

TABLE 2
Examples of capsules colored with natural colorants.

| Trial | H₂O | | Dye | Capsule | H₂O:Capsule | H₂O:Shell | |
|---|---|---|---|---|---|---|---|
| # | (wt %) | Dye | (wt %) | (wt %) | mass ratio | mass ratio | Comments |
| 10 | 4.7 | a | 0.3 | 95^{c} | 1:20.4 | 1:5.5 | variegated^{f} |
| 11 | 9.3 | a | 0.7 | 90^{c} | 1:9.7 | 1:2.6 | more uniform^{f} |
| 12 | 14.0 | a | 1.0 | 85^{c} | 1:6.1 | 1:1.6 | uniform^{f} |
| 13 | 18.7 | a | 1.3 | 80^{c} | 1:4.3 | 1:1.2 | uniform^{g} |
| 14 | 4.7 | b | 0.3 | 95^{d} | 1:20.4 | 1:4.6 | variegated^{f} |
| 15 | 9.3 | b | 0.7 | 90^{d} | 1:9.7 | 1:2.2 | more uniform^{f} |
| 16 | 14.0 | b | 1.0 | 85^{d} | 1:6.1 | 1:1.4 | uniform^{f} |
| 17 | 18.7 | b | 1.3 | 80^{d} | 1:4.3 | 1:1.0 | uniform^{g} |
| 18 | 18.2 | b | 1.3 | 80.5^{c} | 1:4.4 | 1:1.2 | uniform^{f} |
| 19 | 14.0 | a | 1.0 | 85^{e} | 1:6.1 | 1:1.6 | uniform^{f} |
| 20 | 18.2 | b | 1.3 | 80.5^{e} | 1:4.4 | 1:1.2 | uniform^{f} |

a Linablue ® spirulina;
b EXBERRY ® “Cherry Red” Powder GNT Product No. 153901;
^{c}1.2 mm gellan-based seamless capsule, dried, 23 wt % film;
^{d}2.5 mm gelatin-based seamless capsule, dried; 27 wt % film;
^{e}1 mm gellan/HAS-based seamless capsules, dried, 27 wt % film;
^{f}free-flowing solids;
^{g}slightly sticking.

While the present invention was illustrated by the description of one or more embodiments thereof, and while embodiments have been described in considerable detail, they are not intended to restrict or in any way limit the scope of the appended claims to such detail. Additional advantages and modification will readily appear to those skilled in the art. The invention in its broader aspects is therefore not limited to the specific details, representative product and method, and illustrative examples shown and described. Accordingly, departures may be made from such details without departing from the scope of the general inventive concept embraced by the following claims.

1. A method for making colored hydrogel-based materials, comprising:
a. applying an aqueous colorant composition comprising water and a colorant material to an external surface of a plurality of hydrogel-based materials, comprising
a hydrogel matrix based on a gelling agent selected from the group consisting of gelatin, pectin, alginate, casein, gellan gum, carragheenan, agar, pullulan gum, or combinations thereof, and
one or more active ingredients;
b. mixing the aqueous colorant composition and the plurality of hydrogel-based materials for a sufficient duration of time to allow substantially all of the aqueous colorant composition to be absorbed into the hydrogel matrix; and
c. optionally, drying the colored hydrogel-based materials at a temperature sufficient to remove at least a portion of the water absorbed into the hydrogel matrix thereby leaving the colorant material therein,
wherein the aqueous colorant composition comprises less than 25% (v/v) of an aqueous miscible co-solvent.

2. The method according to claim 1, wherein the aqueous colorant composition comprises less than 10% (v/v) of the aqueous miscible co-solvent.

3. The method according to claim 1, wherein the aqueous colorant composition is substantially void of any aqueous miscible co-solvent.

4. The method according to claim 1, wherein the hydrogel matrix further comprises a filler.

5. The method according to claim 1, wherein the hydrogel matrix further comprises a filler affecting plasticizing properties to the hydrogel matrix.

6. The method according to claim 1, wherein the plurality of hydrogel-based materials comprise seamless hydrogel capsules comprising a hydrogel shell surrounding an oil-based inner core.

7. The method according to claim 1, wherein the plurality of hydrogel-based materials comprise seamless hydrogel capsules comprising a hydrogel shell surrounding an oil-based inner core comprising one or more flavor or fragrance ingredients.

8. The method according to claim 1, wherein the plurality of hydrogel-based materials comprise seamless hydrogel capsules comprising a hydrogel shell surrounding an oil-based inner core comprising one or more flavor or fragrance ingredients having a Log K_{o/w} less than 2.

9. The method according to claim 1, wherein the plurality of hydrogel-based materials comprise seamless hydrogel capsules comprising a hydrogel shell surrounding an oil-based inner core, wherein 10 wt % or more of the oil-based inner core comprises one or more flavor or fragrance ingredients having a Log K_{o/w} less than 2.

10. The method according to claim 1, wherein the colorant material comprises a thermally unstable dye that undergoes a change in a color appearance parameter, when subjected to a temperature in excess of a thermal degradation temperature of the colorant material, wherein the thermal degradation temperature of the colorant material is 80° C. or less.

11. The method according to claim 1, wherein the colorant material comprises blue phycocyanins.

12. The method according to claim 1, wherein a ratio of a mass of the aqueous colorant composition to a mass of the plurality of hydrogel-based materials is within a range of about 1:1 to about 1:19.

13. A colored hydrogel-based material, produced according to the method of claim 1.

14. A food product comprising the colored hydrogel-based material of claim 13.

15. A colored hydrogel-based material, comprising:
a hydrogel matrix comprising a gelling agent selected from the group consisting of gelatin, pectin, alginate, casein, gellan gum, carragheenan, agar, pullulan gum, or combinations thereof, and
one or more active ingredients,
wherein a colorant material is inhomogeneously dispersed and absorbed into a surface of the hydrogel matrix to form a colored hydrogel matrix, whereby a higher concentration of the colorant material is present near the surface of the colored hydrogel matrix.

16. The colored hydrogel-based material according to claim 15, wherein the colorant material comprises a thermally-unstable dye.

17. The colored hydrogel-based material according to claim 15, wherein the colorant material comprises blue phycocyanins.

18. The colored hydrogel-based material according to claim 15, wherein the colored hydrogel matrix is substantially void of any aqueous miscible co-solvents.
